(19) United States
(12) Patent Application Publication
(10) Pub. No.: US 2026/0001373 A1
(43) Pub. Date: Jan. 1, 2026

(54) ADJUSTABLE WIDTH WHEEL RIM

(71) Applicant: Manuel CALDERA FONG, Mexicali (MX)

(72) Inventor: Manuel CALDERA FONG, Mexicali (MX)

(21) Appl. No.: 19/127,394

(22) PCT Filed: Oct. 17, 2023
(86) PCT No.: PCT/MX2023/050061

§ 371 Date: May 5, 2025

(30) Foreign Application Priority Data
Nov. 8, 2022 (MX) MX/A/2022/014061

(51) Int. Cl. B60B 19/04; B60B 25/02

(52) U.S. Cl. CPC B60B 19/04; B60B 25/02

(57) ABSTRACT

This disclosure relates to an adjustable width wheel rim, or more particularly, an assemblable, adjustable-width rim for mounting tires on motor vehicles. The adjustable width wheel rim may include a central tubular drum with two lateral sections delimited by a central section with two annular stop edges. Each lateral section is configured to axially receive a double-walled “C”-shaped insert up to a stop. Each insert includes a thread on the outer wall and a thread on the inner wall, allowing it to be screwed onto double-walled “C”-shaped tire mounting rings with a closed-end, defining an outer wall with an internal thread and an inner wall with an internal thread. These tire mounting rings and inserts include axial through-holes at their closed ends, designed to axially receive bolts that penetrate through axial holes in the annular edge of the central tubular drum to secure the entire assembly.

### CROSS REFERENCE TO RELATED APPLICATIONS

This application a 371 of international application number PCT/MX2023/050061, filed Oct. 17, 2023, which claims priority to MX patent application number MX/a/2022/014061, filed Nov. 8, 2022, both of which are incorporated herein by reference in their entireties.

### FIELD OF THE INVENTION

The present invention relates to mechanics in general, and in particular to the industry of manufacturing central metal parts of the wheel of a vehicle, on which the tires are mounted, known as rims.

### DISCUSSION OF THE BACKGROUND

In the automotive industry today, it is known that vehicles generally require a wheel system to move, and within this system, the wheels are designed and configured to mount rims on tires are well known. According to the Royal Spanish Academy, the rim is a central metal piece of the wheel of a vehicle, on which the tire is mounted. The function of a rim is to receive and hold a tire, and is designed and configured to be mounted and fastened to the suspension mount. The suspension mount supports the rim and tire, and is sometimes connected to other systems that connect with the power transmission.

The dimensions and specifications of strength, structure, design, and shape of the rims are precisely calculated with respect to the capacities and dimensions of the vehicle. There are different types of rims depending on the manufacturing material such as steel, aluminum, magnesium or alloy rims and according to their design and structure there may be sports rims and classic rims or according to the requirements of their application, such as those for commercial and industrial use.

Rim size depends on the type of vehicle, its size and weight, as well as the rim's use or destination, and changing them affects the alignment, braking and acceleration, as well as the calibration of the speedometer and/or other aspects of the vehicle. The rims are designed and configured to mount and support the tires, and for this purpose it is also necessary to take into account the type of tires that are going to be mounted on it. Generally, most tires share the following structure: a tread (the area or surface with which the tire makes contact with the road surface on which it rolls), a shoulder (the area where the tread and the sidewall meet), a sidewall (the lateral area of the tire and whose end edge defines the bead), a bead (that fits between the rim bed or bead seat and the lip, eyebrow or flange of the rim when it is mounted-together the lip, eyebrow or flange and bead prevent the tire from coming off the rim).

A problem that currently exists in the field of the rim industry for vehicle tires is that the rims are designed and configured by manufacturers with very specific height and width dimensions, depending on the type of vehicle, weight, the use that the vehicle will have, whether it is a vehicle for private use, passengers, cargo, for the city or for the countryside, among others, wherein the rims are designed and manufactured with very specific shapes and dimensions in height and width for each vehicle.

Additionally, there are rims that are manufactured with the consumer's taste in mind (e.g., aesthetics, shape and appearance), and consequently, if a consumer who has a certain vehicle that was purchased with a specific type, shape and design of rims, and has the need or the taste to fit other rims of another design, shape and aesthetics that allow mounting another tire size, he/she has to buy other rims. This usually means that he/she has another additional expense added to the purchase. The same happens if he/she wants to change the width of the rims, for example, to change some driving/performance parameters, to improve the appearance of the vehicle with tires of larger diameter rims, or to save in maintenance costs (since tires of smaller diameter are generally much cheaper), and these changes are only possible as long as the safety criteria are present.

Accordingly, manufacturers are then required to produce different rims for a vehicle, each with different designs, structures, shapes and dimensions. This then makes the manufacture's costs higher, requires a larger storage area for inventory, and increases their production and transportation costs, etc. Alternately, customized rims can be manufactured for the vehicle and purchaser's taste, using Custom Numerical Control (CNC). However, the cost of custom built rims is high (around $5,000). Further, once they are manufactured, their width cannot be varied.

On the other hand, there are certain types of modular rims, where the center or central star can be exchanged, and it can vary in position: towards the external body (“positive displacement rims), exactly in the center (“zero displacement rims”), or towards the internal body (“negative displacement rims”), depending on the design and configuration of the rim. Notwithstanding, the entire circumference, ring or drum of the rim has to be purchased depending on the position where you want to position the center and they are very expensive rims costing on the order of $3,000 and $3,500 dollars, from very prestigious brands. Further, due to low demand (e.g., due to the excessive price), this type of rim is generally limited to high-end vehicles.

Document CN209521478 by Wu Chengyuan of Dec. 18, 2018 shows an adjustable rim which is formed by combining a left rim assembly and a right rim assembly and comprises an embedding piece, a spoke, an axle matching piece, a fixing matching body, an adjustment piece, an adjustment element and a clamping shaft, and the clamping adjustment body is provided with a positioning hole matching with a positioning shaft on the axle clamp; the adjustment element is matched with the adjustment piece; and the adjustment body on the adjustment element rotates to drive the thread pieces at two ends of the adjustment body to perform horizontal movement of the adjustment pieces matched with the adjustment element. It provides an adjustable rim that can make the rim and the tire fit more closely and improve the fit between the rim and the tire, thereby effectively solving the problem of insufficient fit. However, this rim is a rim designed to be able to generate an adjustment in the tire mount in terms of its diameter, it allows the most precise adjustment only in diameter and its width cannot be adjusted.

Document KR101347172 (B1) by Mun Hwa Seong dated Dec. 17, 2012 was also located which discloses a tire test wheel having an adjustable rim width which is a wheel used when the diameter thereof is the same and the rim width thereof is changed, wherein the tire test wheel is used when the rim width of a tire is changed not in fast drive but in a stationary state or a slow drive test where load stress is small in a laboratory. For the purpose of the present disclosure, the tire wheel comprises a center part (3) connected and fastened to an axle; a spoke member (4) extending radially from the center part (3); and a rim edge (5) connected to the spoke member (4) to have a tire mounted thereon. A spring damper (7) elastically supported by a spring (6) is connected between the front surface part (5a) and rear surface part (5b) of the rim edge (5). A slave bevel gear (8a) mounted on the spring damper (7) gears with a driving bevel gear (8b). The rim edge (Y), which is a distance between the front surface part (5a) and rear surface part (5b) of the rim edge (5), is adjusted by varying the axis (7a) of the spring damper (7) because the slave bevel gear (8a) gearing with the driving bevel gear (8b) is operated by the rotation of the rotational axis (10) of a screw as the axis (9) of the driving bevel gear (8b) gears with the inner spiral part (10a) of the rotational axis (10) of the screw using a screw-coupling method. However, as can be seen, the structural configuration of the rim of said document is considerably different from that of present disclosure, and is also intended only for tire testing, that is, it could not be installed on a vehicle to mount a tire for daily use because it is not configured to withstand loads and stresses.

The present disclosure is directed toward overcoming known problems and problems discovered by the inventor. For example, in order to solve the existing problem that has already been widely explained, the present disclosure was developed, which describes below a standard rim that can be assembled and adjusted in width for mounting tires on automotive vehicles for domestic, commercial or industrial use, in all its variants, which has the particularity of being able to adjust its width to different tire widths as required, providing it complies with any relevant additions criteria (e.g., safety, security, etc.). Further, given the need for an assemblable rim that is width-adjustable for mounting tires on automotive vehicles for domestic, commercial or industrial use, in all its variants, and being able to adjust its width to different tire widths as required, this disclosure was developed, which is undoubtedly a technological advance in this field of the automotive industry.

### SUMMARY OF THE INVENTION

An assemblable rim that is width-adjustable for mounting tires on automotive vehicles is disclosed herein. The assemblable rim is an adjustable wheel rim that is width-adjustable for mounting tires on automotive vehicles for domestic, commercial or industrial use, in all desired variants, which has the particularity of being able to adjust its width to different tire widths as required.

Generally, the assemblable rim/adjustable wheel rim includes a central tubular drum, two C-shaped inserts, and two C-shaped tire mounting rings.

The central tubular drum defines two inner and outer lateral sections, delimited by a central section defining two annular stop edges spaced apart from each other, wherein each lateral section includes on its outer and inner faces throughout its circumferential surface a plurality of anti-rotation edges and channels in an axial direction, alternating with each other.

Next, each of the two C-shaped inserts are formed by a double-walled tubular body, defining an outer wall and an inner wall whose inner faces have a plurality of anti-rotation edges and channels in an axial direction alternating with each other to allow their axial coupling in the inner and outer lateral sections of the central tubular drum, up to the limit of a sealed end in each of the C-shaped inserts. Further, each of the inserts include a cord on the outer surface of the outer wall and an outer cord on the outer surface of the inner wall.

Finally, each of the two C-shaped tire mounting rings includes a sealed end with a protruding annular lip, flange or tab where the tire bead is retained, preventing the tire from being dismounted, and each ring comprising a double wall defining an outer wall with a cord on its inner surface and an inner wall with a cord on its inner surface, with which they are each threaded into the corresponding C-shaped insert. Further, the C-shaped tire mounting rings and C-shaped inserts include respective axial through holes in the sealed ends configured to axially receive fastening means that penetrate up to holes made axially in the annular edges of the inner and outer lateral ends of the central tubular drum to fasten the complete assembly.

The assemblable rim further includes: a reinforcing ring with a plurality of radial through holes is mounted with fastening means in holes made radially in the central zone inside the central tubular drum, a central disc ring mounting rim is fastened with the same fastening means as the reinforcing ring, in holes made radially in the inner face of the mounting ring, a central disc ring, a threaded tire inflation pivot, and a tire anti-dismounting safety drum insert.

The central disc ring is fastened to the central disc ring mounting rim with fastening means mounted axially in axial through holes made close to its outer edge and in axial holes made in the central disc ring mounting rim. The central disc ring includes a central hole and both through holes distributed circumferentially around the central hole, for the passage of the end of the mass cylinder and the rim fixing studs, respectively. The threaded tire inflation pivot is configured to be inserted into a threaded pivot hole axially formed in the edge of the central tubular drum which extends axially to its central section and which also passes through the outer side of the corresponding C-shaped insert and the outer side of the corresponding C-shaped tire mounting ring. The tire anti-dismounting safety drum insert is inserted into the tire prior to its mounting on the rim, the end edges of which, once installed, abut the inner area of the tire bead which prevents it from dismounting towards the inner area of the rim, and which comprises a plurality of tabs in its circumferential wall so that the inflation air of the tire circulates and the tire can be inflated.

### BRIEF DESCRIPTION OF THE DRAWINGS

For a better understanding of the disclosure, a detailed description of some of its embodiments will be made, shown in the drawings that are attached to this description for illustrative but non-limiting purposes.

FIG. 1 is an exploded view of an assemblable rim that is width-adjustable for mounting tires on automotive vehicles, showing various components, including a central tubular drum, a C-shaped insert, a C-shaped tire mounting ring, a reinforcing ring, a rim center disc mounting ring, a rim center disc, and a tire anti-dismounting safety drum insert, according to one embodiment of the present disclosure.

FIG. 2 is a detail view of the central tubular drum of FIG. 1.

FIG. 3 is an axial section of the central tubular drum of FIG. 2.

FIG. 4 is a detail view of one C-shaped insert of FIG. 1.

FIG. 5 is a cutaway view of the C-shaped insert of FIG. 4, showing its structural configuration.

FIG. 6 is a detail view of the C-shaped tire mounting ring of FIG. 1.

FIG. 7 is a cross section of the C-shaped tire mounting ring of FIG. 6.

FIG. 8 is a detail view of the reinforcing ring of FIG. 1.

FIG. 9 is a detail view of the rim center disc mounting of FIG. 1.

FIG. 10 is a detail view of the rim center disc of FIG. 1.

FIG. 11 is a detail view of the tire anti-dismounting safety drum insert of FIG. 1, which is mounted inside a tire before being mounted on the rim of the present disclosure.

FIG. 12 is an unexploded view of FIG. 1, showing the assemblable rim with the tire mounted.

### DETAILED DESCRIPTION OF THE PREFERRED EMBODIMENTS

Reference will now be made in detail to the preferred embodiments of the disclosure, examples of which are illustrated in the accompanying drawings. Further, the characteristic details of the modifiable wheel rim or, more particularly, the assemblable rim that is width-adjustable for mounting tires on automotive vehicles are clearly shown in the following description and in the attached illustrative drawings, the same reference signs being used to indicate the same parts.

While the disclosure will be described in conjunction with the preferred embodiments, it should be understood that they are not intended to limit the disclosure to these embodiments. On the contrary, the disclosure is intended to cover alternatives, modifications, and equivalents that may be included within the spirit and scope of the invention as defined by the appended claims. Furthermore, in the following detailed description of the present disclosure, numerous specific details are set forth in order to provide a thorough understanding of the present disclosure. However, it will readily be apparent to one skilled in the art that the present disclosure may be practiced without these specific details.

This disclosure relates to a modifiable wheel rim or, more particularly, an assemblable, adjustable-width rim for mounting tires on motor vehicles. It may include a central tubular drum with two lateral sections delimited by a central section with two annular stop edges. Each lateral section is configured to axially receive a double-walled “C”-shaped insert up to a stop. Each insert includes a thread on the outer wall and a thread on the inner wall, allowing it to be screwed onto double-walled “C”-shaped tire mounting rings with a closed-end, defining an outer wall with an internal thread and an inner wall with an internal thread. These tire mounting rings and inserts include axial through-holes at their closed ends, designed to axially receive bolts that penetrate through axial holes in the annular edge of the central tubular drum to secure the entire assembly. Additionally, the disclosure features a threaded inflation valve, a reinforcement ring mounted inside the drum, and a mounting ring for the center disc, which is fixed to the reinforcement ring and, in turn, secured to the rim center disc.

An objective of the present disclosure is to make available an assemblable rim that is width-adjustable for mounting tires on automotive vehicles that allows for flexibility in its assembly and reduces existing manufacturing and storage costs by being able to modify its width and adjust it for another required tire size. Another objective of the disclosure is to provide said assemblable rim that is width-adjustable for mounting tires on automotive vehicles, which also allows to reduce storage volumes and offers consumers the possibility of avoiding the purchase of various rims of other designs, structures or center configurations for the same vehicle, provided that the performance or specifications, use, type and size of the vehicle or the needs of the user are met. Another objective of the disclosure is to provide said assemblable rim that is width-adjustable for mounting tires on automotive vehicles, which also reduces production costs and in turn reduces the sale price for the consumer. Another objective of the disclosure is to provide said assemblable rim that is width-adjustable for mounting tires on automotive vehicles, which also reduces the raw material in its manufacture, and reduces the waste of raw material in its manufacture. Another objective of the disclosure is to provide said assemblable rim that is width-adjustable for mounting tires on automotive vehicles, which also offers high security regarding its structural and mechanical resistance. Another objective of the disclosure is to provide said assemblable rim that is width-adjustable for mounting tires on automotive vehicles, which also has the particularity of being able to modify its width to accept and mount more or less wide tires. Another objective of the disclosure is to provide said assemblable rim that is width-adjustable for mounting tires on automotive vehicles, which also allows its centers to be exchanged for centers of different configurations, designs, shapes and positions, offering manufacturers a range of possibilities for rim combinations that cannot currently be achieved. Another objective of the disclosure is to provide all those qualities and objectives that will become apparent when making a general and detailed description of the present disclosure supported by the illustrated embodiments.

In general, the assemblable rim that is width-adjustable for mounting tires on automotive vehicles may include a central tubular drum that, when viewed from the front in a horizontal position, defines two inner and outer lateral sections delimited by a central section that defines two annular stop edges spaced apart from each other; wherein each lateral section comprises on its outer face and on its inner face a plurality of anti-rotation edges and channels in an axial direction, alternating with each other throughout its circumferential surface configured to axially receive a C-shaped insert, wherein each C-shaped insert is made up of a double-walled tubular body, defining an outer wall and an inner wall whose inner faces have the same configuration as a plurality of anti-rotation edges and channels in an axial direction alternating with each other to allow their axial displacement in said inner and outer lateral sections of the central tubular drum, up to a sealing wall that acts as a sealed end or stop in each of said C-shaped inserts; and wherein each insert comprises a cord on the outer surface of the outer wall and an outer cord on the outer surface of the inner wall, each C-shaped insert configured to threadably receive a C-shaped tire mounting ring; wherein each of these rings comprises a sealed end with a protruding annular lip also called a flange or tab where the bead is retained, preventing it from being disassembled, and each ring for mounting C-shaped tires comprising a double wall defining an outer wall with a cord on its inner surface and an inner wall with a cord on its inner surface with which they are threaded into said C-shaped inserts; wherein said rings for mounting C-shaped tires, said C-shaped inserts comprise respective axial through holes in the sealed ends configured to axially receive fastening means that penetrate the holes made axially in the annular edges of the inner and outer ends of said central tubular drum to fasten the complete assembly; a reinforcing ring with a plurality of radial through holes is mounted with fastening means in holes made radially in the central zone inside said central tubular drum and a central disc ring mounting rim is fastened with the same fastening means of said reinforcing ring, arranged in a radial direction, in holes made in a radial direction in the inner face of said mounting ring and finally a central disc ring that is fastened to said central disc ring mounting rim with fastening means mounted axially in axial through holes made close to its outer edge and in axial holes made in said central disc ring mounting rim; wherein said central disc ring comprises a central hole and respective through holes distributed circumferentially around said central hole, for the passage of the end of the mass cylinder and the rim fixing studs, respectively; said central tubular drum comprises a threaded pivot hole that extends axially on its edge and that also passes through the C-shaped insert on the outer side and the C-shaped tire mounting ring on the outer side, where a threaded tire inflation pivot is installed.

In the preferred embodiment of the disclosure the width of the C-shaped inserts is equivalent to the width of the side sections of the central tubular drum.

In the preferred embodiment of the disclosure said rings for mounting C-shaped tires are interchangeable with others of greater or lesser width, that is, their length can vary to offer a greater or lesser width depending on the width of the tire to be mounted.

In another of the embodiments of the disclosure, said C-shaped inserts, like said C-shaped tire mounting rings, are interchangeable with others of greater or lesser width, to offer a greater or lesser width disclosure on the width of the tire to be mounted.

In another embodiment of the disclosure, the length of said C-shaped inserts is equal to the length of said C-shaped tire mounting rings and its length determines the width of the tire that will be mounted on the rim of the present disclosure.

In the preferred embodiment of the disclosure, said rim also comprises a tire anti-dismounting safety drum insert that is inserted into the tire prior to its mounting on the rim, and wherein its end edges press against the inner area of the tire bead, preventing it from being dismounted towards the inner area of the rim, and which comprises a plurality of tabs in its circumferential wall so that the inflation air of the tire circulates and the tire can be inflated.

In the preferred embodiment of the disclosure, said tire anti-dismounting safety drum insert comprises an annular central area on the inner face of which it comprises a plurality of edges and channels in the axial direction alternating with each other over its entire circumferential surface configured to slide axially on the corresponding edges and channels alternating with each other defined on the circumferential outer face of the central section of said central tubular drum to prevent said tire anti-dismounting safety drum insert from rotating.

In the preferred embodiment of the disclosure, said tire anti-dismounting safety drum insert comprises at its end edges two circumferential channels with rounded edges designed to be fastened with clamping elements of the machines, mandrels or equipment used to fasten and insert it into the tires and facilitate placement of the tire on the rim.

In the preferred embodiment of the disclosure, said threaded bore of the pivot of said central tubular drum ends before reaching one of the annular stop edges of the central section of said central tubular drum with a reduction that allows the passage of air and prevents the pivot from being introduced further inside, and in turn acts as a counter wall or stop to house a rubber ring that is arranged between the channel and the pivot.

In the preferred embodiment of the disclosure, said central section, which defines two annular stop edges spaced apart from each other and which delimits its two lateral sections of said central tubular drum, defines a circumferential tire mounting channel which allows the passage of the tire bead in an angular manner and parallel to the face of the rim, towards the end of its final mounting.

In the preferred embodiment of the disclosure, the central area inside said central tubular drum where said reinforcing ring is fastened is a channel that is located in the inner center of the side of the inner face and surrounds the circumference of said central tubular drum and comprises a plurality of holes made in a radial direction to receive fastening means that fastens said reinforcing ring.

In the preferred embodiment of the disclosure, said circumferential tire mounting channel defined in said central section defining two annular stop edges spaced apart from each other and delimiting its two lateral sections of said central tubular drum, comprises a slope in the area of the inner section that facilitates the mounting of the tire bead.

In the preferred embodiment of the disclosure, said reinforcing ring comprises a cross-cut that allows the reduction of its diameter to facilitate its assembly within the central area inside said central tubular drum.

In another embodiment of the disclosure, said C-shaped inserts comprise an outer annular channel arranged close to the sealed end, configured to allow it to be fastened by means of tools commonly used for mounting tires, to facilitate their mounting.

In another embodiment of the disclosure, said C-shaped inserts comprise a circumferential gland channel formed on the face of the sealed end and configured to house a rubber ring with a hermetic seal with respect to the corresponding ring for mounting C-shaped tires; to prevent air from escaping.

In another of the preferred embodiments of the disclosure, said C-shaped tire mounting rings define in the area of the sealed end an inner circumferential stop section, with rounded edges to prevent the tire bead from moving inwards once mounted, on a circumferential flatbed section or bead seat where the tire bead sits, and which is adjacent to the outer area with respect to said inner circumferential stop section; a pending circumferential bead section arranged on the outside between the circumferential flatbed or bead seat and which is auxiliary in the mounting of the tire bead, facilitating its positioning in said circumferential flatbed section, or bead seat; and finally a protruding annular lip section, flange or tab; distributed circumferentially, designed to prevent the tire bead from coming out of the rim once mounted.

In another embodiment of the disclosure, said C-shaped tire mounting rings define an annular clamping channel with rounded edges close to the sealed end, designed to be clamped by means of clamping tools for installation.

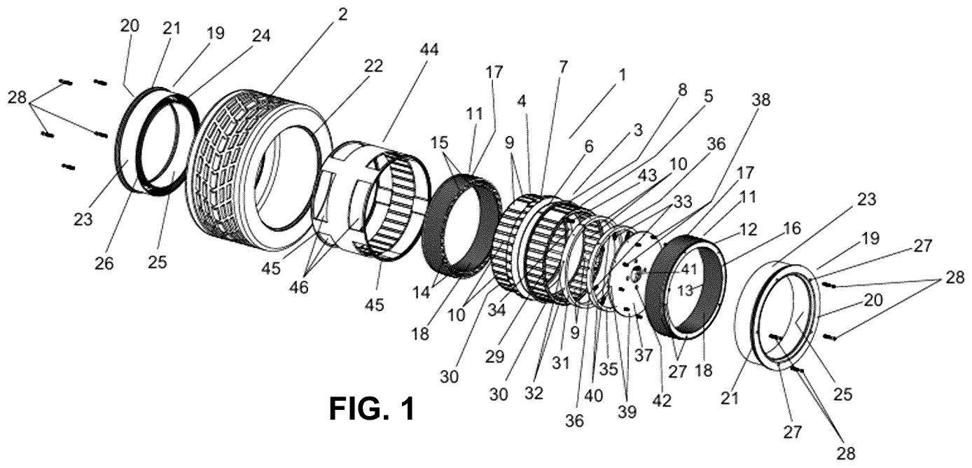

FIG. 1 is an exploded view of a modifiable wheel rim or, more particularly, an assemblable rim that is width-adjustable for mounting tires on automotive vehicles, according to one embodiment of the present disclosure. As shown, a tire (2) may be mounted to an adjustable width wheel rim, see assemblable rim (1). Generally, the adjustable width wheel rim may include a central tubular drum, at least one adjustable spacer adjustably coupled to the central tubular drum, and configured to modify the rim's width, a means to fix the at least one adjustable spacer once the rim's width is set, a power transmission interface configured to transfer torque between the vehicle and the central tubular drum, and at least one tire mount configured to couple at least one of an inner and outer side of the tire to the central tubular drum via the at least one adjustable spacer.

According to one embodiment, the assemblable rim (1) may include a central tubular drum (3), at least one C-shaped inserts (11), at least one C-shaped tire mounting ring (19), and a power transmission interface. The power transmission interface may include a reinforcing ring (31), a rim center disc mounting ring (35), a rim center disc (37).

The central tubular drum (3) which, when viewed from the front in a horizontal position, defines an inner lateral section (4) and an outer lateral section (5) delimited by a central section (6) that defines two annular stop edges (7, 8) spaced apart from each other; wherein each side section comprises on its outer face and on its inner face a plurality of anti-rotation edges (9) and anti-rotation channels (10), axially distributed, alternating with each other throughout its circumferential surface configured to axially receive the C-shaped inserts (11).

Each C-shaped insert (11) is made up of a double-walled tubular body, defining an outer wall (12) and an inner wall (13) whose inner faces have the same configuration of a plurality of anti-rotation edges (14) and anti-rotation channels (15) in an axial direction alternating with each other, so as to allow their axial displacement in said inner (4) and outer (5) lateral sections of the central tubular drum (3), up to a sealing wall that acts as a sealed end (16) in each of said C-shaped inserts (11). Each C-shaped insert (11) includes an outer cord (17) on the outer surface of the outer wall (12), and an outer cord (18) on the outer surface of the inner wall (13). Each C-shaped insert (11) is configured to receive a C-shaped tire mounting ring (19) in a threaded manner,

Each C-shaped tire mounting ring (19) includes a sealed end (20) with a protruding annular lip, flange or tab (21), where the bead (22) of the tire (2) is retained. The bead (22) is mounted against the bead bed or seat (54, see FIG. 7) of C-shaped tire mounting ring (19), which prevents it from being dismounted. Each C-shaped tire mounting ring (19) further includes a double wall defining an outer wall (23) with a cord (24) on its inner surface and an inner wall (25) with a cord (26) on its inner surface with which they are threaded into said C-shaped inserts (11). Both the C-shaped tire mounting rings (19) and the C-shaped inserts (11) include respective axial through holes (27) in the sealed ends (16, 20), which are configured to axially receive fastening means (28) (e.g., bolts, nuts, studs, stems, etc.) that penetrate to holes (29) made axially in the edges (30) of the ends of the inner (4) and outer (5) lateral sections of said central tubular drum (3) to fasten the complete assembly.

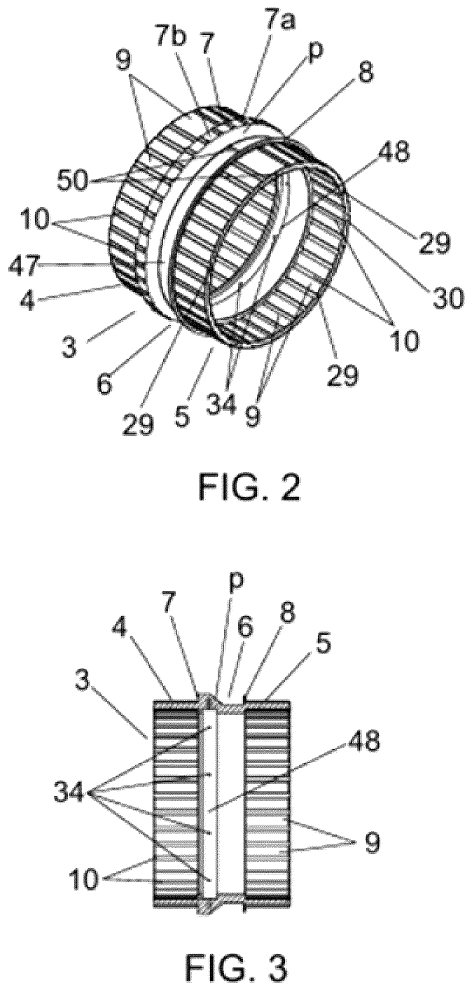

The reinforcement ring (31) includes a plurality of through holes (32) in a radial direction is mounted with fastening means (33) in holes (34, see FIGS. 2 and 3) made in a radial direction in the central zone inside said central tubular drum (3).

The rim center disc mounting ring (35) is fastened with the same fastening means (33) of said reinforcement ring (31), arranged in a radial direction, in holes (36) made radially in the inner face of said mounting ring (35).

Finally, the rim center disc (37) that is fastened to the rim center disc mounting ring (35) with fastening means (38) mounted axially in axial through holes (39) made close to its outer edge and in axial holes (40) made in the rim center disc mounting ring (35). The rim center disc (37) includes a central hole (41) and respective through holes (42) distributed circumferentially around said central hole (41), for the passage of the end of the mass cylinder and the rim fixing studs, respectively. The central tubular drum (3) includes a threaded pivot hole (50, see FIG. 2) extending axially at its edge, and also passing through the C-shaped insert (11) on the outer side and the C-shaped tire mounting ring (19) on the outer side, where a threaded tire inflation pivot (43) is installed.

According to one embodiment, the assemblable rim that is width-adjustable (1) may also include a tire anti-dismounting safety drum insert (44). In particular, and as shown, the tire anti-dismounting safety drum insert (44) may include end edges (45) and a plurality of tabs (46) or passageways. The tire anti-dismounting safety drum insert (44) may be inserted into the tire (2) prior to its mounting on the rim. When installed, the end edges (45) abut the inner area of the bead (22) of the tire (2) that prevents it from being dismounted towards the inner area of the rim. Further, the plurality of tabs (46) are located in its circumferential wall so that the inflation air of the tire (2) circulates and the tire can be inflated.

FIG. 2 is a detail view of the central tubular drum of FIG. 1. FIG. 3 is an axial section of the central tubular drum of FIG. 2. As shown, the central tubular drum (3) defines an inner lateral section (4) and an outer lateral section (5) delimited by the central section (6) which defines the two annular stop edges (7, 8) spaced apart from each other; wherein each lateral section comprises on its outer face and on its inner face a plurality of anti-rotation edges (9) and anti-rotation channels (10), axially distributed, alternating with each other on its entire circumferential surface configured to axially receive a C-shaped insert (11, see FIG. 1).

The central section (6) defines two annular stop edges (7, 8) spaced apart from each other and delimiting its two lateral, inner (4) and outer (5) lateral sections of said central tubular drum (3). This then defines a circumferential tire mounting channel (47) which allows the passage of the bead (22 see FIG. 2) of the tire (2) in an angular manner and parallel to the face of the rim, towards the end of its final mounting.

The central tubular drum (3) may include a central area (48) inside said central tubular drum (3). The reinforcing ring (31, see FIG. 1) may be fastened to central area (48) where a channel located at the inner center of the inner face side and surrounds the circumference of the central tubular drum (3). Further, the central area (48) may include a plurality of holes (34) made in a radial direction to receive fastening means that fastens the reinforcing ring (31).

The circumferential tire mounting channel (47) defined in said central section 6) defining two annular stop edges (7, 8) spaced apart from each other and delimiting its two inner (4) and outer (5) lateral sections of said central tubular drum (3), may include a slope (p) in the area of the inner section adjacent to the annular stop edge (7) that facilitates the mounting of the bead (22, see FIG. 1) of the tire (2, see FIG. 1).

As shown, the central tubular drum (3) may also include a threaded pivot hole (50) that ends before the slope (p) adjacent to the annular stop edge (7) of the central section (6). The threaded pivot hole (50) may have a reduction that allows the passage of air and prevents the threaded tire inflation pivot (43, see FIG. 1) from being introduced further inside, and in turn acts as a counter wall or stop to house a rubber ring that is arranged between the channel and the pivot.

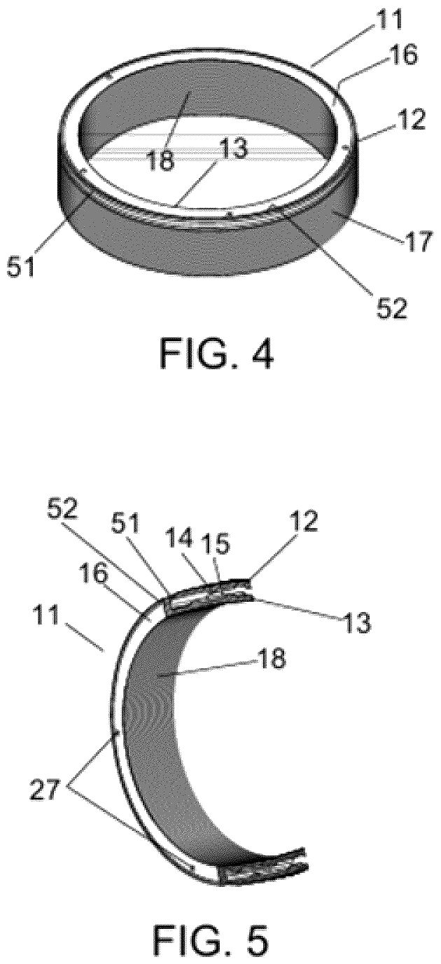

FIG. 4 is a detail view of one C-shaped insert of FIG. 1. FIG. 5 is a cutaway view of the C-shaped insert of FIG. 4, showing its structural configuration. As above, the C-shaped inserts (11) are made up of a double-walled tubular body defining an outer wall (12) and an inner wall (13) whose inner faces have the same configuration of a plurality of anti-rotation edges (14), and anti-rotation channels (15) in an axial direction alternating with each other to allow their axial displacement in said inner (4, see FIGS. 2, 3) and outer (5, see FIGS. 2, 3) lateral sections of the central tubular drum (3), up to a sealing wall that acts as a sealed end (16) in each of said C-shaped inserts (11); and wherein each insert includes an outer cord (17) on the outer surface of the outer wall (12) and an outer cord (18) on the outer surface of the inner wall (13).

In addition, the C-shaped inserts (11) may include respective axial through holes (27) passing through the sealed end (16), and configured to axially receive the fastening means (28, see FIG. 1) that penetrate up to holes (29, see FIGS. 1 and 2) made axially in the edges (30, see FIGS. 1 and 2) of the ends of the inner (4) and outer (5) lateral sections of said central tubular drum (3, see FIGS. 1 and 2) to fasten the complete assembly.

As shown, the C-shaped inserts (11) may include an outer annular channel (51) arranged close to the sealed end, and configured to allow its attachment by means of tools commonly used for mounting tires, to facilitate their mounting. In addition, the C-shaped inserts (11) may include a circumferential gland channel (52) made on the face of the sealed end (16), and configured to house a rubber ring for hermetic sealing (not shown) with respect to the corresponding C-shaped tire mounting ring (19, see FIG. 1) to prevent the escape of air.

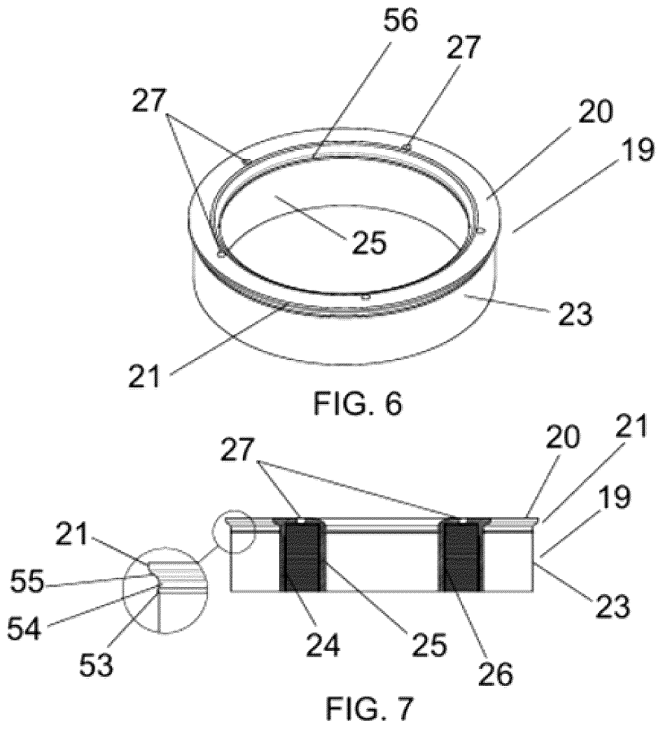

FIG. 6 is a detail view of the C-shaped tire mounting ring of FIG. 1. FIG. 7 is a cross section of the C-shaped tire mounting ring of FIG. 6. As above, the C-shaped tire mounting rings (19) may include a sealed end (20) with a protruding annular lip, flange or tab (21) where the bead (22, see FIG. 1) of the tire (2, see FIG. 1) is retained. Since the bead (22) is mounted on the bead bed or seat (54), it is prevented from being disassembled. Further, each C-shaped tire mounting rings (19) may include a double wall defining an outer wall (23) with a cord (24) on its inner surface, and an inner wall (25) with a cord (26) on its inner surface, with which they are threaded into the C-shaped inserts (11, see FIGS. 4 and 5). In addition, the C-shaped tire mounting rings (19) may include respective axial holes (27) passing through the sealed end (20) configured to axially receive fastening means (28, see FIG. 1) that penetrate into the holes (29, see FIGS. 1 and 2) made axially in the edges (30, see FIGS. 1 and 2) of the ends of the inner (4) and outer (5) lateral sections of said central tubular drum (3, see FIGS. 1 and 2) to fasten the complete assembly.

The C-shaped tire mounting rings (19) define in the area of the sealed end (20) an inner circumferential stop section (53), a bead seat (54), a circumferential bead slope section (55), and an annular protrusion (21). The inner circumferential stop section (53) may have rounded edges, and be configured to prevent the bead (22) of the tire (2) from moving inwards once mounted on the bead seat (54). The bead seat (54) may be configured as a circumferential flatbed section where the bead (22) of the tire (2) sits, and which is adjacent towards the outer area with respect to said inner circumferential stop section (53).

The circumferential bead slope section (55) may be arranged outside with respect to said circumferential flatbed section or bead seat (54), and is assistive in the mounting of the bead (22) of the tire (2), facilitating its positioning in said circumferential flatbed section or bead seat (54). The annular protrusion (21) may be configured as a protruding annular lip section, flange or tab, which is distributed circumferentially and designed to prevent the bead (22) of the tire (2) from coming off the rim once mounted.

According to one embodiment, the C-shaped tire mounting rings (19) may further define an annular clamping channel (56) with rounded edges close to the sealed end (20) on the inner wall (25). In particular, the annular clamping channel (56) may be configured for clamping, by means of clamping tools for installation.

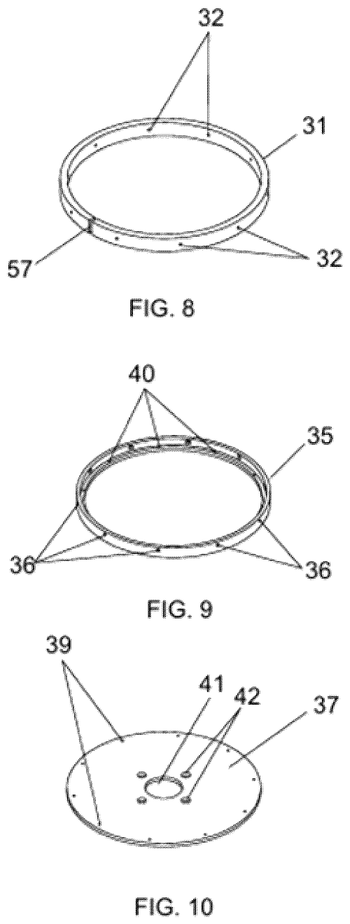

Referring now to FIGS. 8-10, FIG. 8 is a detail view of the reinforcing ring of FIG. 1, FIG. 9 is a detail view of the rim center disc mounting of FIG. 1, and FIG. 10 is a detail view of the rim center disc of FIG. 1. As above, the reinforcing ring (31) may include a plurality of through holes (32) in a radial direction through which the fastening means (33, see FIG. 1) are introduced into the holes (34, see FIGS. 2 and 3) made in a radial direction in the central zone inside said central tubular drum (3, see FIGS. 2 and 3). The reinforcing ring (31) may have a cross-section (57) that allows the reduction of its diameter to facilitate its assembly within the central zone (48, see FIGS. 2 and 3) inside said central tubular drum (3, see FIGS. 2 and 3).

As shown, the center rim disc mounting ring (35) may include a plurality of through holes (36) made in a radial direction through which the same fastening means (33, see FIG. 1) are passed to be fastened together with the reinforcement ring (31, see FIG. 8) in holes (34, see FIGS. 2 and 3) made in a radial direction in the central area inside said central tubular drum (3).

As above, the center disc mounting ring (35) may be fastened with fastening means (33, see FIG. 1) arranged both in the through holes (36) made in said mounting ring (35) and in the holes (32) made in said reinforcing ring (31), and finally the center disc (37) which is fastened to said center disc mounting ring (35) with fastening means (38, see FIG. 1) mounted axially in axial through holes (39) made close to its outer edge and in axial holes (40) made in said center disc mounting ring (35); wherein said rim center disc (37) comprises a central hole (41) and respective through holes (42) distributed circumferentially around said central hole (41), for the passage of the end of the mass cylinder and the rim fixing studs (not shown), respectively.

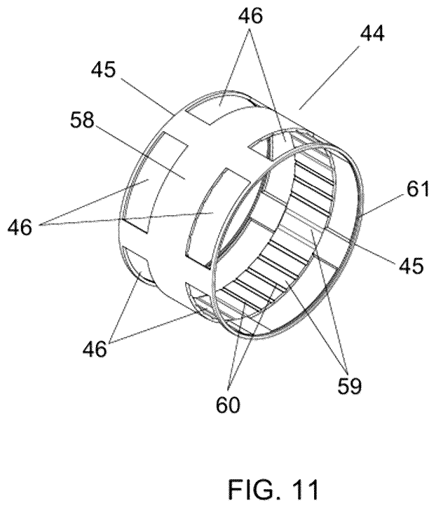

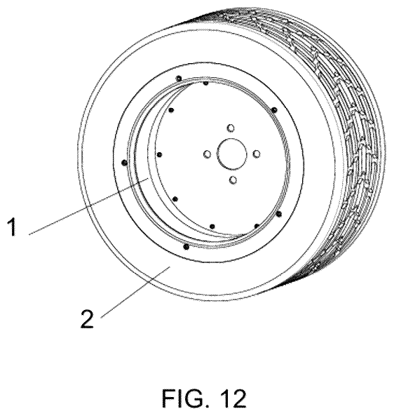

FIG. 11 is a detail view of the tire anti-dismounting safety drum insert of FIG. 1, which is mounted inside a tire before being mounted on the rim of the present disclosure As above, tire anti-dismounting safety drum insert (44) may be inserted into the tire (2, see FIGS. 1 and 12) prior to its mounting on the rim (1), where its end edges (45) abut the inner area of the bead (22, see FIG. 1) of the tire (2, see FIG. 1), which prevents it from being dismounted towards the inner area of the rim, and which includes a plurality of passageways or tabs (46) in its circumferential wall so that the inflation air of the tire (2) circulates and the tire can be inflated.

According to one embodiment, the tire anti-dismounting safety drum insert (44) may include an annular central area (58) on the inner face of which it includes a plurality of anti-rotation edges (59) and anti-rotation channels (60) in the axial direction alternating with each other throughout its circumferential surface. The tire anti-dismounting safety drum insert (44) may be configured to slide axially on corresponding anti-rotation edges (7a, see FIG. 2) and anti-rotation channels (7b, see FIG. 2) defined on the circumferential outer face of the annular stop edge (7) of said central tubular drum (3) to prevent rotation of said tire anti-dismounting safety drum insert (44).

According to one embodiment, the tire anti-dismounting safety drum insert (44) ma include at its end edges two circumferential channels (61) with rounded edges designed to be fastened by clamping elements of the machines, mandrels or equipment used to fasten and insert it into the tires and facilitate the placement of the tire on the rim.

FIG. 12 illustrates a conventional perspective view of an assemblable rim that is width-adjustable (1) for mounting tires (2) on automotive vehicles of the present disclosure with a tire mounted, in the preferred embodiment of the disclosure.

The above description of the various embodiments is provided to enable a person of ordinary skill in the art to make or use the subject matter of the disclosure. Various modifications to the embodiments will be readily apparent to those skilled in the art, and the generic principles defined herein may be applied to other variations without departing from the spirit or the scope of this disclosure. Thus, it is to be understood that the disclosure is not intended to be limited to the examples and designs described herein, which merely represent a presently preferred implementation of the disclosure, but that the disclosure is to be accorded the widest scope consistent with the principles and novel features disclosed herein. It is to be further understood that the scope of the present disclosure fully encompasses other embodiments that may become obvious to those skilled in the art.

What is claimed is:

1. An assemblable rim that is width-adjustable for mounting tires on automotive vehicles, characterized by comprising:
a central tubular drum defining two inner and outer lateral sections, delimited by a central section defining two annular stop edges spaced apart from each other; wherein each lateral section comprises on its outer and inner faces throughout its circumferential surface a plurality of anti-rotation edges and channels in an axial direction, alternating with each other;
two C-shaped inserts each formed by a double-walled tubular body, defining an outer wall and an inner wall whose inner faces have a plurality of anti-rotation edges and channels in an axial direction alternating with each other to allow their axial coupling in said inner and outer lateral sections of the central tubular drum, up to the limit of a sealed end in each of said C-shaped inserts; and wherein each of said inserts comprises a cord on the outer surface of the outer wall and an outer cord on the outer surface of the inner wall;
two C-shaped tire mounting rings, each comprising a sealed end with a protruding annular lip, flange or tab where the tire bead is retained, preventing the tire from being dismounted, and each ring comprising a double wall defining an outer wall with a cord on its inner surface and an inner wall with a cord on its inner surface, with which they are each threaded into the corresponding C-shaped insert;
wherein said C-shaped tire mounting rings and said C-shaped inserts comprise respective axial through holes in the sealed ends configured to axially receive fastening means that penetrate up to holes made axially in the annular edges of the inner and outer lateral ends of said central tubular drum to fasten the complete assembly;
a reinforcing ring with a plurality of radial through holes is mounted with fastening means in holes made radially in the central zone inside said central tubular drum;
a central disc ring mounting rim is fastened with the same fastening means as said reinforcing ring, in holes made radially in the inner face of said mounting ring;
a central disc ring is fastened to said central disc ring mounting rim with fastening means mounted axially in axial through holes made close to its outer edge and in axial holes made in said central disc ring mounting rim; wherein said central disc ring comprises a central hole and both through holes distributed circumferentially around said central hole, for the passage of the end of the mass cylinder and the rim fixing studs, respectively;
a threaded tire inflation pivot configured to be inserted into a threaded pivot hole axially formed in the edge of said central tubular drum which extends axially to its central section and which also passes through the outer side of the corresponding C-shaped insert and the outer side of the corresponding C-shaped tire mounting ring; and
a tire anti-dismounting safety drum insert which is inserted into the tire prior to its mounting on the rim, the end edges of which, once installed, abut the inner area of the tire bead which prevents it from dismounting towards the inner area of the rim, and which comprises a plurality of tabs in its circumferential wall so that the inflation air of the tire circulates and the tire can be inflated.

2. The assemblable rim that is width-adjustable for mounting tires on automotive vehicles, according to claim 1, characterized by the fact that said rings for mounting C-shaped tires are interchangeable with others of greater or lesser width depending on the width of the tire to be mounted.

3. The assemblable rim that is width-adjustable for mounting tires on automotive vehicles, according to claim 1, characterized by the fact that said C-shaped inserts, like said rings for mounting C-shaped tires, are interchangeable with another of greater or lesser width, depending on the width of the tire to be mounted.

4. The assemblable rim that is width-adjustable for mounting tires on automotive vehicles, according to claim 1, characterized by the fact that the length of said C-shaped inserts is equal to the length of said C-shaped rings for mounting tires and their length determines the width of the tire that will be mounted on the rim.

5. The assemblable rim that is width-adjustable for mounting tires on automotive vehicles, according to claim 1, characterized by the fact that said tire anti-dismounting safety drum insert comprises an annular central area on the inner face of which it comprises a plurality of edges and channels in an axial direction alternating with each other throughout its circumferential surface that fit with the corresponding alternating axial edges and channels of the circumferential outer face of the central section of said central tubular drum to prevent said tire anti-dismounting safety drum insert from rotating.

6. The assemblable rim that is width-adjustable for mounting tires on automotive vehicles, according to claim 1, characterized by the fact that said tire anti-dismounting safety drum insert comprises two circumferential channels on its end edges designed to be fastened with clamping elements of the machines, mandrels or equipment used to fasten and insert it into the tires and facilitate placement of the tire on the rim.

7. The assemblable rim that is width-adjustable for mounting tires on automotive vehicles, according to claim 1, characterized by the fact that said threaded pivot hole of said central tubular drum ends before reaching one of the annular stop edges of the central section of said central tubular drum with a reduction that allows the passage of air and prevents the pivot from being introduced further inside, and in turn, it acts as a counter wall or stop to house a rubber ring that is arranged between the channel and the pivot.

8. The assemblable rim that is width-adjustable for mounting tires on automotive vehicles, according to claim 1, characterized by the fact that said central section that defines two annular stop edges spaced apart from each other and that delimits its two lateral sections of said central tubular drum, defines a circumferential tire mounting channel which allows the passage of the tire bead in an angular manner and parallel to the face of the rim, towards the end of its final assembly.

9. The assemblable rim that is width-adjustable for mounting tires on automotive vehicles, according to claim 8, characterized by the fact that said circumferential tire mounting channel defined in said central section that defines two annular stop edges spaced apart from each other and that delimits its two lateral sections of said central tubular drum, comprises a slope in the area of the inner section that facilitates the mounting of the tire bead.

10. The assemblable rim that is width-adjustable for mounting tires on automotive vehicles, according to claim 1, characterized by the fact that said reinforcement ring comprises a cross-section that allows the reduction of its diameter to facilitate its mounting within the central area inside said central tubular drum.

11. The assemblable rim that is width-adjustable for mounting tires on automotive vehicles, according to claim 1, characterized by the fact that said C-shaped inserts comprise an outer annular channel arranged close to the sealed end, configured to allow its fastening by means of tools commonly used for mounting tires, to facilitate their mounting.

12. The assemblable rim that is width-adjustable for mounting tires on automotive vehicles, according to claim 1, characterized by the fact that said C-shaped inserts comprise a circumferential gland channel made in the face of the sealed end and configured to house a rubber ring with a hermetic seal with respect to the corresponding ring for mounting C-shaped tires; to prevent air from escaping.

13. The assemblable rim that is width-adjustable for mounting tires on automotive vehicles, according to claim 1, characterized by the fact that said C-shaped tire mounting rings also define in the area of the sealed end an inner circumferential stop section with rounded edges to prevent the tire bead from moving inward once mounted on a circumferential flatbed section or bead seat where the tire bead sits and which is adjacent to the outer area with respect to said inner circumferential stop section; a circumferential bead slope section arranged on the outside with respect to said circumferential flatbed section or bead seat and which is auxiliary in the mounting of the tire bead by facilitating its positioning in said circumferential flatbed section or bead seat; said circumferential bead slope section being adjacent to said protruding annular lip section, flange or tab that prevents the tire bead from coming out of the rim once mounted.

14. The assemblable rim that is width-adjustable for mounting tires on automotive vehicles, according to claim 1, characterized by the fact that said C-shaped tire mounting rings define an annular fastening channel with rounded edges close to the sealed end designed for fastening by means of fastening tools for its installation.
